(19) United States
(12) Patent Application Publication
(10) Pub. No.: US 2023/0316198 A1
(43) Pub. Date: Oct. 5, 2023

(54) AUTOMATIC SIMULTANEOUS OPTIMIZATION FOR MULTI-ELEMNET PRICE WATERFALL VIA ADAPTIVE MULTI-AGENT OPTIMIZATION ENGINE

(71) Applicant: PriceFx Inc., Chicago, IL (US)

(72) Inventors: Sylvain Rougemaille, Toulouse (FR); Florent Dotto, Bordeaux (FR)

(73) Assignee: PriceFx Inc., Chicago, IL (US)

(21) Appl. No.: 17/710,693

(22) Filed: Mar. 31, 2022

(51) Int. Cl. G06Q 10/06; G06Q 30/02

(52) U.S. Cl. CPC G06Q 10/06375; G06Q 30/0283

(57) ABSTRACT

A system optimizes price waterfall elements simultaneously using a multi-agent optimization engine. The multi-agent optimization engine may be implemented as an adaptive multiple agent system that includes multiple software agents. The agents interact among each other and their environment to optimize the price waterfall elements simultaneously in order to meet user-defined objectives for revenue and/or profit. The multi-agent optimization engine enables each price waterfall element (e.g., initial list price, an initial on invoice discount, an initial off invoice rebate, and an initial end of period discount) of the price waterfall to be optimized continuously and simultaneously.

### BACKGROUND

A price waterfall is a representation of the revenue and margin that a company makes from a transaction for a product and a customer. The price waterfall shows how the initial price cascades down to the margin.

Current approaches focus on optimizing only one element of the price waterfall, typically net or selling price. This is limiting because a change to one element of the price waterfall has a ripple effect in relation to other elements of the same waterfall, and has a side effect on waterfalls of other products and customers (e.g., rebate for a family of customer, discount on a category of product). This issue is compounded by the inability of current approaches to factor high level business objective (e.g., total margin or total revenue targets) versus local business objectives (e.g., revenue by product or customer category) into the waterfall optimization, and to deal concurrently with several business constraints associated to customer's agreement (e.g., rebate, discount, and so forth) or customer organization (e.g., sale compensation).

What is needed is improved price waterfall optimization capable of optimizing multiple elements simultaneously.

### SUMMARY

The present technology, roughly described, optimizes a price waterfall using a multi-agent optimization engine. The multi-agent optimization engine includes multiple software agents which interact among each other and their environment to optimize the price waterfall in order to meet user-defined objectives related to revenue and/or profit. The multi-agent optimization engine enables each price waterfall element (e.g., initial list price, an initial on invoice discount, an initial off invoice rebate, and an initial end of period discount) of the price waterfall to be optimized continuously and simultaneously.

In some instances, a method can optimize a price waterfall. The method may include receiving, by a server having one or more processors and memory, an initial price waterfall comprising a plurality of initial price waterfall elements. The initial price waterfall may be associated with a product and has a plurality of successive pricing deductions. The method includes receiving domain data comprising historical transaction data associated with the initial price waterfall. The method further includes optimizing, by a multi-agent optimization engine, the plurality of initial price waterfall elements of the initial price waterfall based on the domain data, thereby forming an optimized price waterfall. The method further includes reporting the optimized price waterfall to a user.

In some instances, a non-transitory computer readable storage medium has embodied thereon a program. The program is executable by a processor to perform a method for optimizing a price waterfall. The method includes receiving, by a server having one or more processors and memory, an initial price waterfall comprising a plurality of initial price waterfall elements. The initial price waterfall is associated with a product and has a plurality of successive pricing deductions. The method further includes receiving domain data comprising historical transaction data associated with the initial price waterfall. The method further includes optimizing, by a multi-agent optimization engine, the plurality of initial price waterfall elements of the initial price waterfall based on the domain data, thereby forming an optimized price waterfall. The method further includes reporting the optimized price waterfall to a user.

In some instances, a system can optimize a price waterfall. The system includes a server including a memory and a processor. The system further includes instructions stored in the memory and executed by the processor to receive an initial price waterfall comprising a plurality of initial price waterfall elements. The initial price waterfall is associated with a product and has a plurality of successive pricing deductions. The instructions are further executed by the processor to receive domain data comprising historical transaction data associated with the initial price waterfall. The instructions are further executed by the processor to optimize, by a multi-agent optimization engine, the plurality of initial price waterfall elements of the initial price waterfall based on the domain data, thereby forming an optimized price waterfall. The instructions are further executed by the processor to report the optimized price waterfall to a user.

### BRIEF DESCRIPTION OF FIGURES

FIG. 1 is a block diagram of a system that automatically optimizes price waterfall elements simultaneously.

FIG. 2 is a block diagram of an optimization application.

FIG. 3 illustrates an exemplary graphic representation of a price waterfall.

FIG. 4 is a method for automatically optimizing price waterfall elements simultaneously.

FIG. 5 is a method for configuring parameters to adjust a price waterfall.

FIG. 6 is a method for receiving scope data associated with optimization scenarios.

FIG. 7 is a method for receiving configuring data associated with desired optimization.

FIG. 8 is a method for automatically optimizing price waterfall elements simultaneously.

FIG. 9 is a method for processing data by AMAS agents within environment to simultaneously optimize multiple elements of a price waterfall.

FIG. 10 is a method for executing optimization with data and library framework code.

FIG. 11 illustrates a model of a multi-agent optimization system.

FIG. 12 illustrates exemplary initial price waterfall elements and optimized price waterfall elements.

FIG. 13 illustrates an exemplary interface for receiving optimization scope values.

FIG. 14 illustrates an exemplary interface for receiving optimization configuration boundaries.

FIG. 15 illustrates an exemplary interface for receiving optimization configuration objectives.

FIG. 16 illustrates an exemplary interface displaying table information.

FIG. 17 illustrates an exemplary interface for displaying an overview of optimization results.

FIG. 18 illustrates an exemplary interface for displaying an initial price waterfall and optimized price waterfall.

FIG. 19 illustrates an exemplary interface for displaying revenue and margin data.

FIG. 20 illustrates an exemplary interface for displaying optimization result details.

FIG. 21 illustrates a computing environment for implementing the present technology.

### DETAILED DESCRIPTION

The present technology, roughly described, optimizes price waterfall elements simultaneously using a multi-agent optimization engine. The multi-agent optimization engine may be implemented as an adaptive multiple agent system that includes multiple software agents. The agents interact among each other and their environment to optimize the price waterfall elements simultaneously in order to meet user-defined objectives for revenue and/or profit. The multi-agent optimization engine enables each price waterfall element (e.g., initial list price, an initial on invoice discount, an initial off invoice rebate, and an initial end of period discount) of the price waterfall to be optimized continuously and simultaneously.

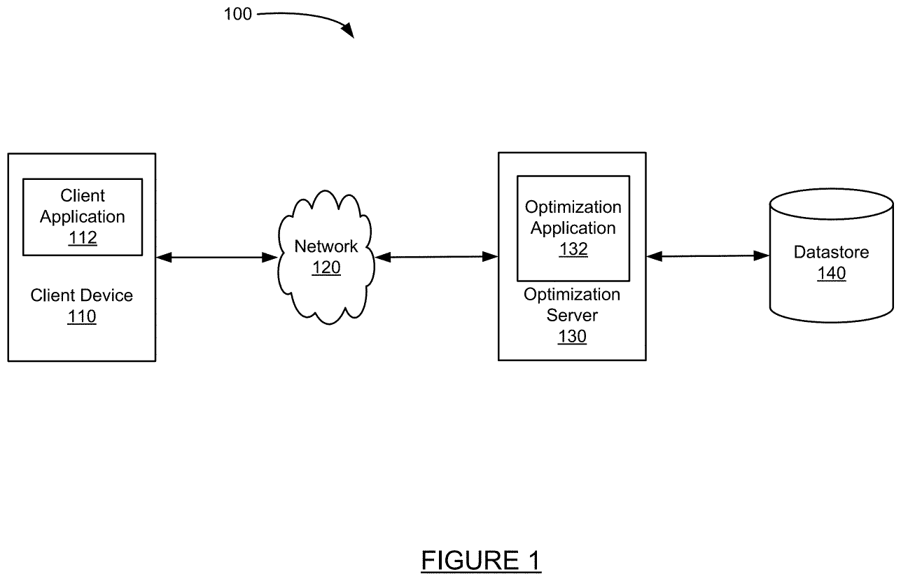

FIG. 1 is a block diagram of a system that automatically optimizes price waterfall elements simultaneously. System 100 of FIG. 1 includes client device 110, network 120, optimization server 130, and data store 140. Client device 110 communicates with optimization server 130 over network 120 and can be implemented as a mobile device, computing device, a workstation, or some other computing machine.

Client device 110 includes client application 112. Client application 112 may communicate with optimization server 130 to provide optimization price waterfall functionality as described herein. Client application 112 may be implemented as one or more applications, objects, modules, or other software. In some instances, client application 112 may be implemented at least in part as a network browser. In this implementation, the network browser may provide one or more graphic user interfaces to receive input through client device 110 and display output received from optimization server 130 through client device 110. The network browser can also transmit received data to optimization server 130 for processing by optimization application 132.

Network 120 may include a private network, public network, the Internet, an intranet, a WAN, a LAN, a cellular network, or some other network suitable for the transmission of data between the devices of FIG. 1.

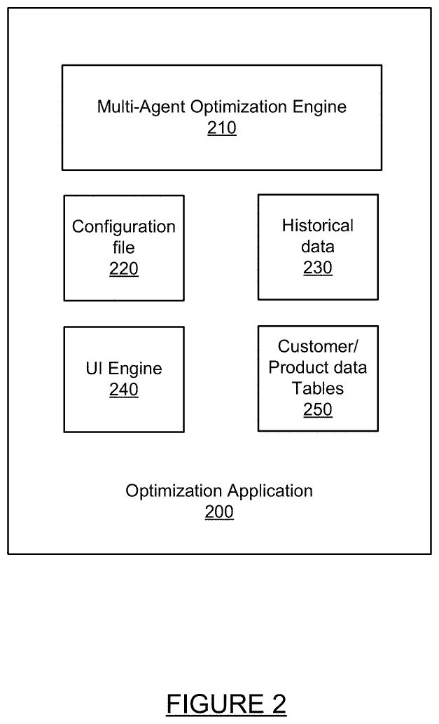

Optimization server 130 includes optimization application 132. The optimization application 132 uses the initial price waterfalls and domain data input from data store 140 to provide an optimized price waterfall as described herein. In particular, the optimization application 132 includes multiple software agents interacting autonomously in order to simultaneously optimize each price waterfall element based on user-defined objectives for revenue and/or profit. Client application 112 may communicate with data store 140 through the optimization server 150 or directly (not illustrated in FIG. 1) to access data stored therein. Optimization application 132 is discussed in more detail with respect to FIG. 2.

Data store 140 may store initial price waterfall data to be optimized by the optimization server 130 using the techniques described herein. Each initial price waterfall may include multiple initial price waterfall elements such as list price, on invoice discounts, off invoice discounts, etc.

Data store 140 may also store associations of the initial price waterfalls with corresponding products. The data store 140 may also store domain data including historical transaction data for the products.

FIG. 2 is a block diagram of an optimization application. Optimization application 200 of FIG. 2 provides more detail for application 132 of FIG. 1. Optimization application includes multi-agent optimization engine 210, configuration file 220, historical data 230, user interface engine 240, and customer/product data tables 250.

Multi-agent optimization engine 210 may perform the optimization functionality described herein. In some instances, the multi-agent optimization engine 210 can include model of an adaptive multi-agent system (AMAS). The adaptive multi-agent system is a system comprising multiple agents that may automatically and simultaneously optimize multiple elements. In some instances, multiple agents are modeled by the present system to implement an environment of multiple agents that automatically and simultaneously optimize multiple elements. In some instances, the autonomous multiple agents optimize price waterfall elements based on historical data, configuration data, and master data for a particular customer and product.

Configuration file 220 includes data for configuring the AMAS. The configuration file may include objectives and constraints for performing an optimization. Historical data 230 may include previous sales and discount data that is used to optimize a price waterfall in conjunction with the configuration file 220. User interface engine 240 may provide a dashboard, for example through the form of a network page provided through a network browser. Customer/product data tables may include configuration file data and other data in the form of tables that can be received by a system that models the multi-agent optimization engine 210.

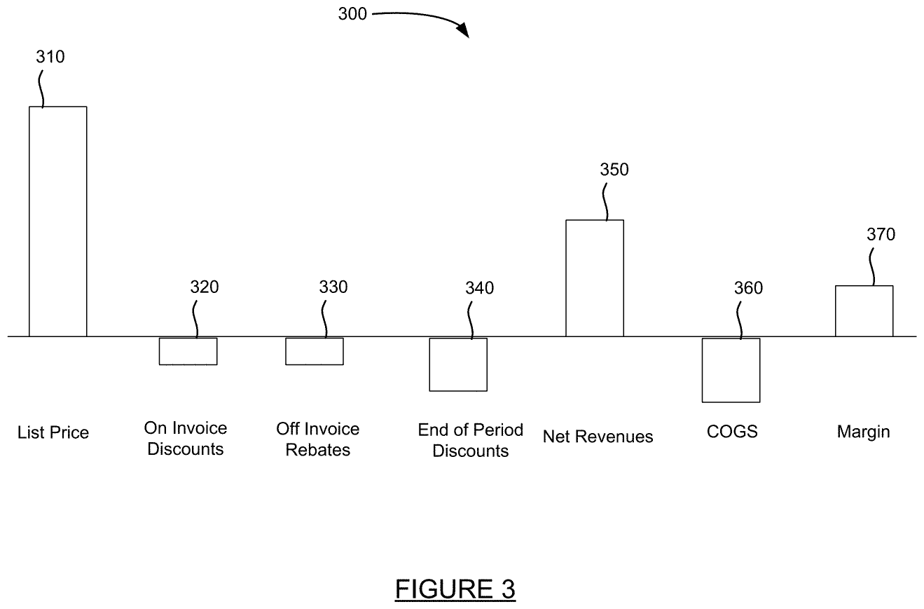

FIG. 3 illustrates a graphical representation of an example price waterfall 300. In this example, the price waterfall elements include list price 310, on invoice discounts 320, off invoice discounts 330, end of period discounts 340, net revenues 350, cost of goods sold (COGS) 360, and margin 370. In other embodiments, the price waterfall elements may be different.

As shown in FIG. 3, the price waterfall 300 includes the list price for a product along with successive pricing deductions (e.g., on invoice discounts, off invoice rebates, end of period discounts, and COGS) that results in net revenue and margin for the product. On invoice discounts are discounts that are explicitly shown on an invoice. Off invoice rebates are price reductions that are not shown on the invoice. End of period discounts are discounts that are offered at the end of a particular period, for example a set time period associated with the product sale.

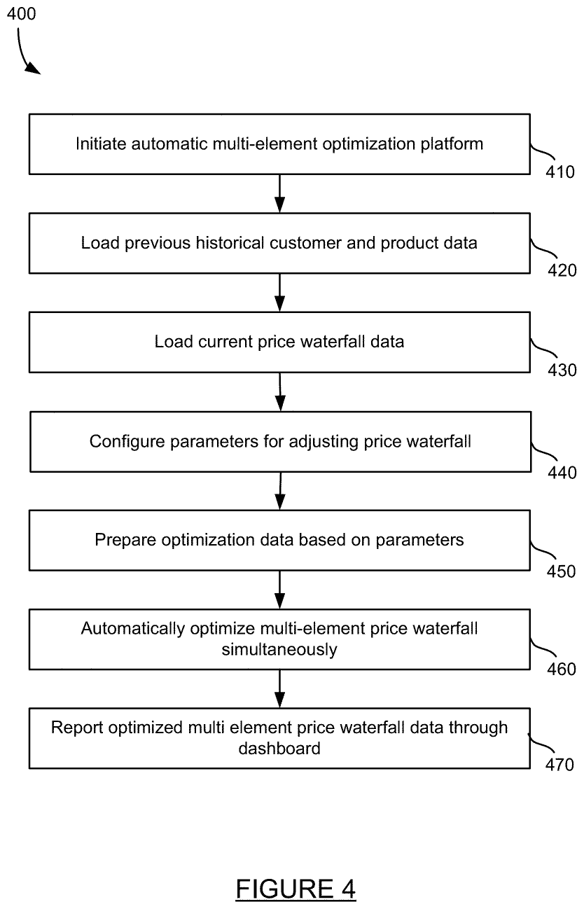

FIG. 4 is a method for automatically optimizing price waterfall elements simultaneously. First, an automatic multi-element optimization platform is initiated at step 410. Initiation may include loading the platform, installing and executing library files, and other initial execution tasks. In some instances, the application may be implemented in Java on a cluster of Kubemetes servers.

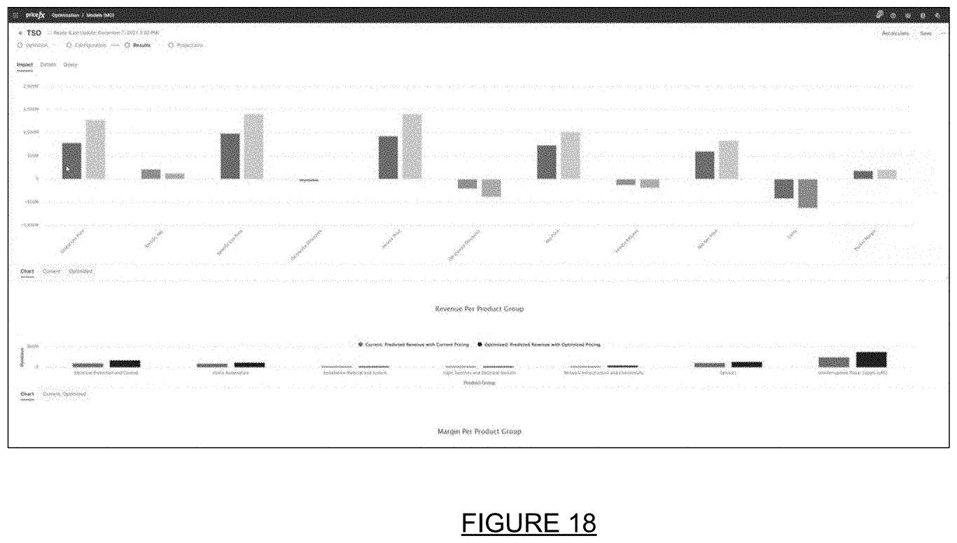

Previous historical customer and product data may be loaded at step 420. Previous historical customer data and product data may include previous sales, previous margins, previous discounts, previous rebates, and other pre-existing data associated with a product or customer. Current price waterfall data may be loaded at step 430. The current price waterfall data may include the current list price, discounts, rebates, revenues, and margins. The previous price waterfall data may be displayed through an interface such as that of FIG. 3 and/or FIG. 18.

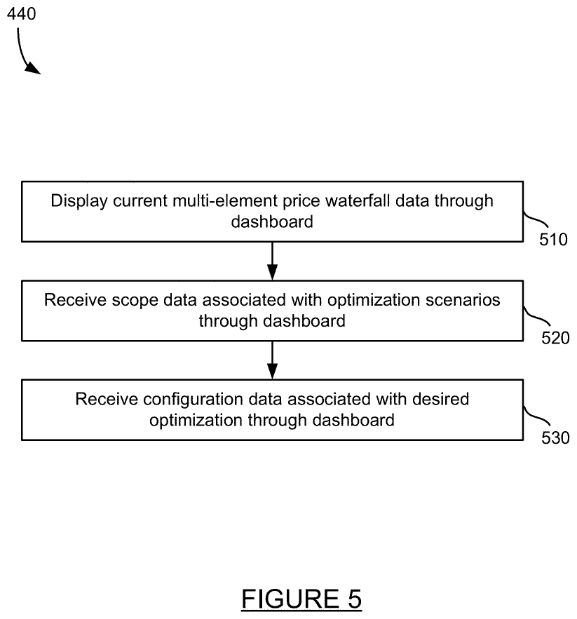

Parameters may be configured for adjusting a price waterfall at step 440. The parameters may relate to scope data, boundaries, objectives, and other data. Configuring parameters for adjusting a price waterfall is discussed in more detail with respect to FIGS. 5-7. Optimization data may be prepared based on the parameters at step 450. Preparing the optimization data may include placing the optimization data in a format that can be received and processed by an adaptive multiagent system or modeled adaptive multiagent system. In some instances, the optimization data and/or parameters are placed in tables based on the scope and configuration data received at step 440.

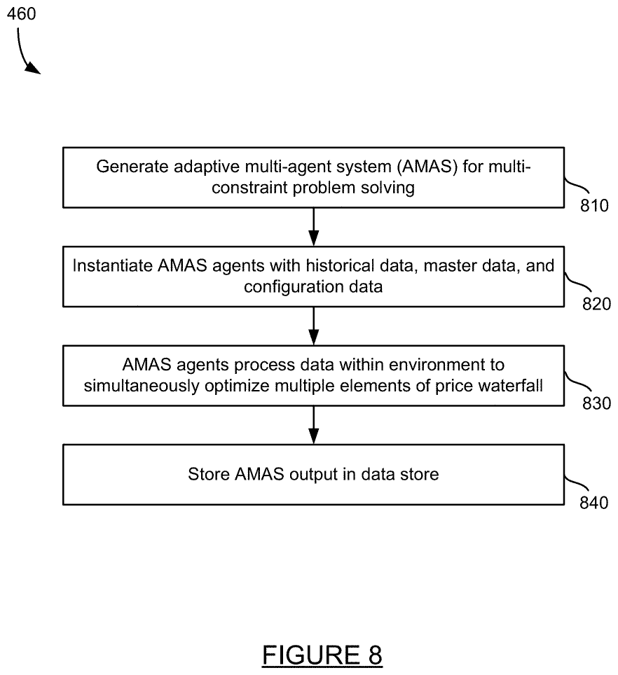

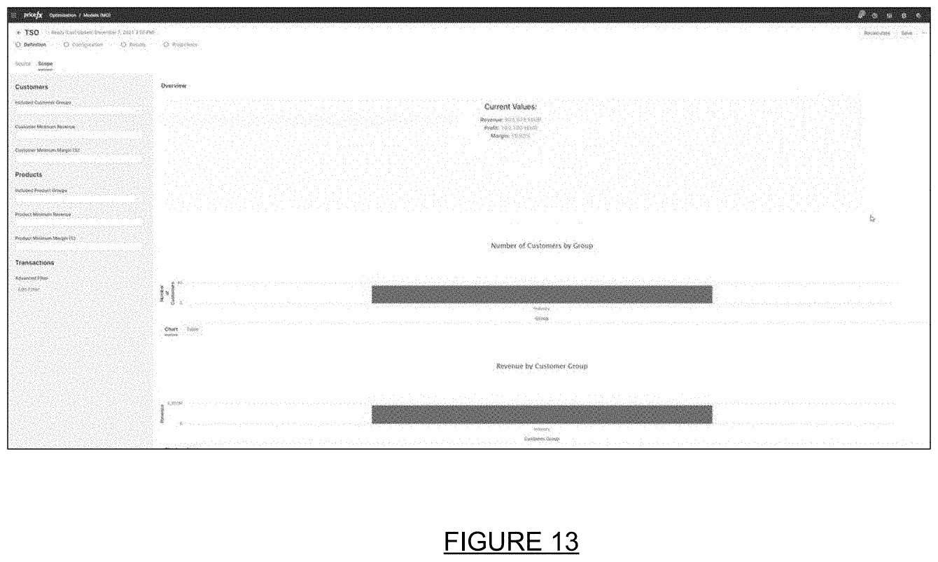

A multi-element price waterfall is automatically optimized at step 460. The multiple elements are optimized simultaneously using the AMAS. More details for optimizing the price waterfall elements is discussed with respect to FIGS. 8-10. The optimized multi-element price waterfall data is reported through a dashboard at step 470. In addition to reporting the data, the price waterfall elements may be dynamically changed by adjusting configurations for the price waterfall. Exemplary interfaces for reporting the price waterfall are displayed with respect to FIGS. 13-20.

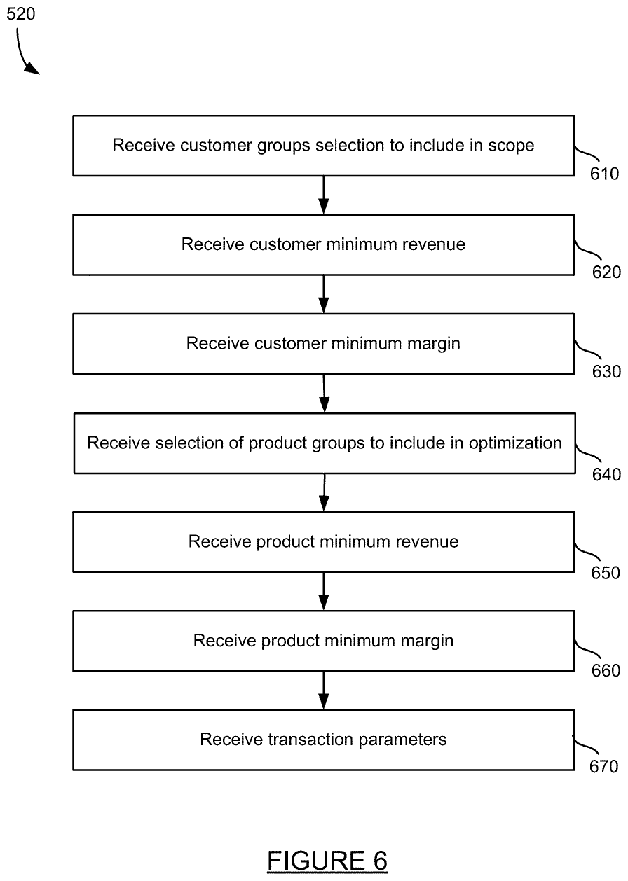

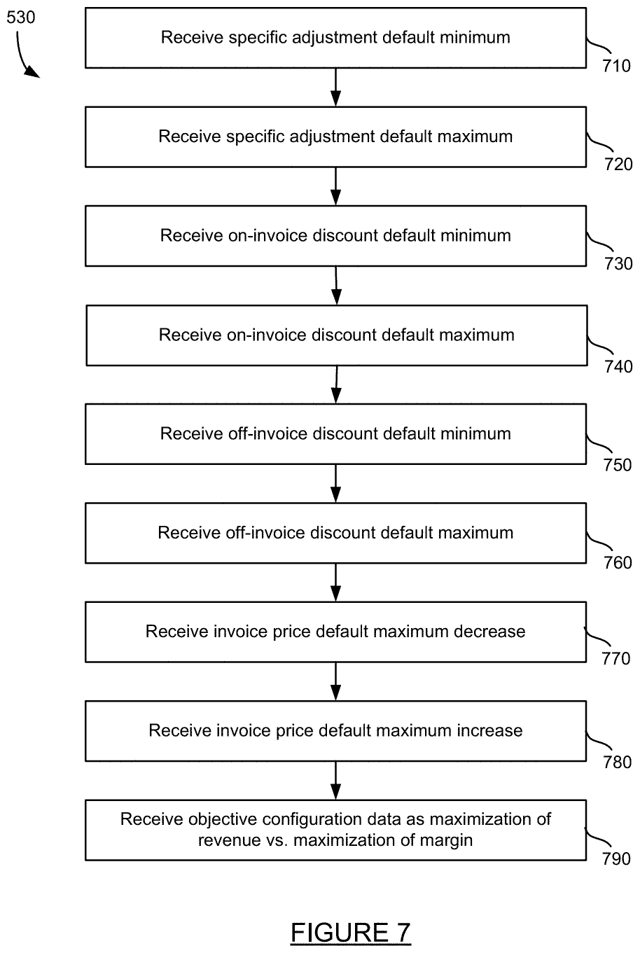

FIG. 5 is a method for configuring parameters to adjust a price waterfall. The method of FIG. 5 provides more detail for step 440 of the method of FIG. 4. First, current multi-element price waterfall data is displayed through a dashboard at step 510. The current multi-element price waterfall data may be based on historical data. Scope data associated with optimization scenarios is then received through the dashboard at step 520. The received scope data may include customer data and product data. More detail for receiving scope data is discussed with respect to the method of FIG. 6. Configuration data associated with a desired optimization may be received through a dashboard at step 530. The configuration data may be associated with specific adjustments, discounts, and other data. More detail for receiving configuration data is discussed with respect to the method of FIG. 7.

FIG. 6 is a method for receiving scope data associated with optimization scenarios. The method of FIG. 6 provides more detail for step 520 of the method of FIG. 5. A customer group selection is received to include within the scope of an optimization at step 610. The customer minimum revenue is received at step 620. A customer's minimum margin is received at step 630.

After receiving customer data, product data can be received. A selection is received of product groups to include in the optimization at step 640. A product minimum revenue can be received at step 650. A product minimum margin can be received at step 660. Transaction parameters can then be received at step 670.

FIG. 7 is a method for receiving configuring data associated with desired optimization. The method of FIG. 7 provides more detail of step 530 of the method of FIG. 5. A specific adjustment default minimum may be received at step 710. A specific adjustment default maximum may be received at step 720. An on invoice discount default minimum may be received at step 730. An on invoice discount default maximum may be received at step 740. An off invoice discount default minimum may be received at step 750. An off invoice discount default maximum may be received at step 760. An invoice price default maximum decrease may be received at step 770. An invoice price default maximum increase may be received at step 780.

Objective configuration data may be received at step 790. The objective configuration data may be received as a balance between a of revenue versus a maximization of margin. In some instances, the balance of maximizing revenue versus maximizing margin may be set as a slider bar between 100% focus on revenue maximization versus hundred percent focus on margin maximization. In some instances, the objective configuration data may be received as a revenue margin coefficient between 0 to 1.

FIG. 8 is a method for automatically optimizing price waterfall elements simultaneously. The method of FIG. 8 provides more detail for step 460 of the method of FIG. 4. First, an adaptive multi-agent system is generated at step 810. The generated adaptive multi-agent system is used for multi-constraint problem-solving. Generating the system may include constructing several types of agents.

In some instances, the agents of an AMAS may include variable agents, computation agents, and criterion agents. Variable agents may include value finders that determine values of list prices and discounts. Variable agents may also determine simple variables, including but not limited to data, parameters, computed variables, and other variables related to things such as costs and margin rates. A computation agent may perform direct computations, such as a margin computation or turnover computation. Criterion agents may receive data from neighboring agents or provide data to a neighboring agent.

In some instances, a value finder agent has one or more neighbors within its particular microenvironment or society of agents, and the value finders change their value to satisfy their neighbors. The neighbors can take the form of criterion agents and have a satisfaction that depends at least in part on the value of the value finder agents. Each neighbor seeks to satisfy its neighbor criterion agent by adjusting its value to be within an accepted range for satisfaction range. In some instances, each value finder may receive feedback from a criterion agent in the form of a dissatisfaction score, importance of the neighbor, and an estimate of the influence of the value finder on the criterion.

AMAS agents may be instantiated based on historical data, master data, and configuration data at step 820. The historical transaction data and master data, consisting of product and customer data and hierarchies, may comprise domain data. The scope and criteria data comprising the AMAS data may comprise problem modeling data.

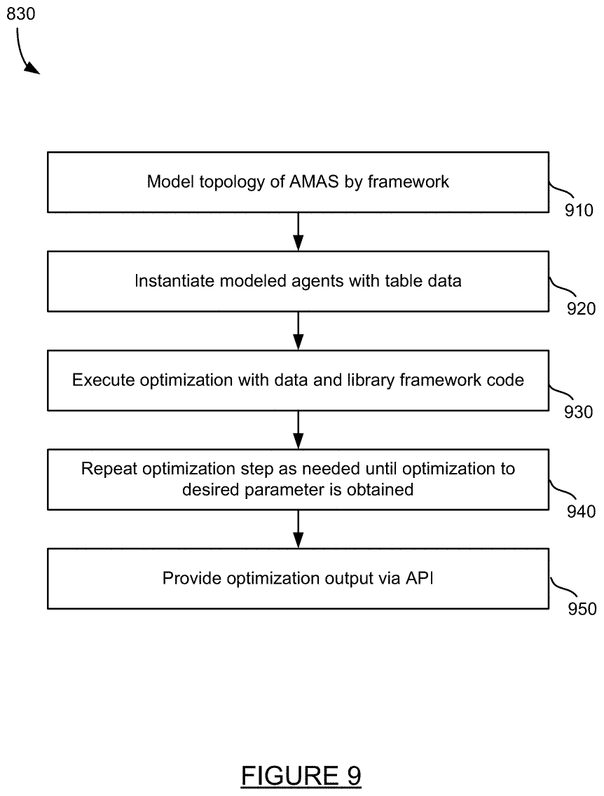

AMAS agents can process the data within an environment to simultaneously optimize multiple elements of a price waterfall at step 830. Optimizing the elements may include modeling a typology of the multi-agent system, instantiating agents, and executing the optimization. More detail for processing data to optimize multiple elements is discussed with respect to the method of FIG. 9. The output of an AMAS system is stored in a data store at step 840. The data store may be implemented locally on an optimization server, at a remote data store, or combination of locations.

FIG. 9 is a method for processing data by AMAS agents within an environment to simultaneously optimize multiple elements of a price waterfall. The method of FIG. 9 provides more detail of step 830 of the method of FIG. 8. A typology of an AMAS is modeled by the current framework at step 910. The modeling may include specifying each agent type, how the agents relate to data, and how they connect to an API. Modeled agents may be instantiated with table data at step 920. In some instances, the system receives a description of a problem, in the form of criteria, levers, and dimensions, as well as problem data and AMAS parameters. The agents model is instantiated with this data and information.

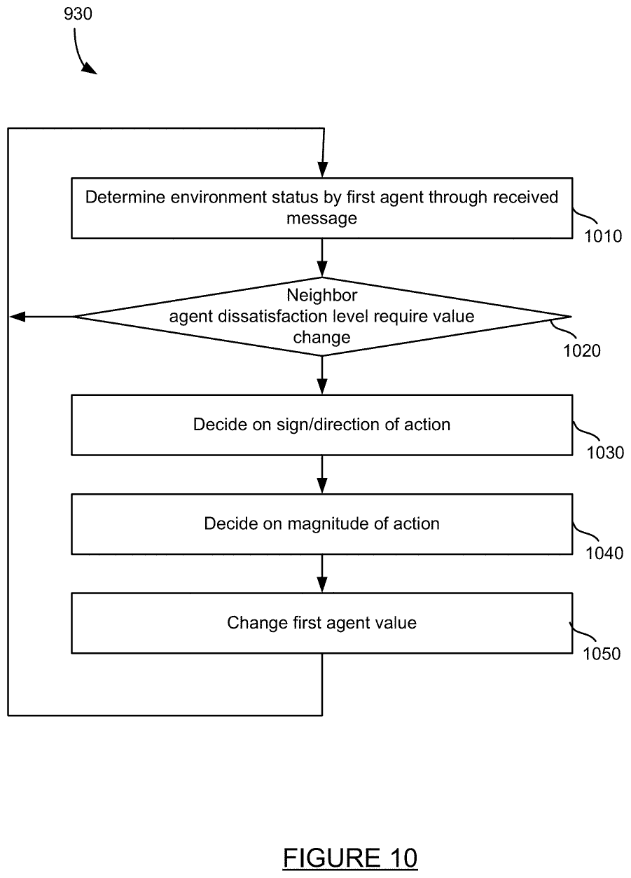

An optimization is executed at step 930. The optimization may be executed with data in library framework code. More details for executing an optimization are discussed with respect to the method of FIG. 10.

Optimization steps can be repeated as needed at step 940. The optimization is repeated, for example, until the desired output prices, discounts, or other levers (or elements) are achieved. In some instances, the optimization stops either after attaining a specific number of steps (for example, as specified in a user interface by a user) or if the multi-agent system has converged. In some instances, the level of satisfaction can be minimal, and the value finders are oscillating at a minimal amplitude.

The optimization output is an accessible via an API at step 950. The optimization results output through the API may be stored in a data store and eventually reported through a dashboard that provides the results data through one or more interfaces, including a price waterfall.

FIG. 10 is a method for executing optimization using data and library framework code. The method of FIG. 10 provides more detail for step 930 of the method of FIG. 9. In some instances, the method of FIG. 10 illustrates an exemplary lifecycle of a value finder agent, wherein at each step of an optimization process each value finder agents executes this process and evaluates whether to change its value depending on feedback the agent receives from its criterion agent neighbors.

A first agent receives messages from neighboring agents at step 1010. The first agent may determine the environment status of the other agents based on the received messages. In some instances, the received messages may indicate a satisfaction level or score of each neighboring agent.

A determination is then made as to whether a neighbor agent's satisfaction level requires a change at the first agent at step 1020. In some instances, if a dissatisfaction level of a neighboring agent is not within an acceptable score range, the first agent may take action. If no changes are required, the method of FIG. 10 returns to step 1010. If change is required, then the agent decides on a sign/direction of action at step 1030 a magnitude of the action is undecided upon by the first agent at step 1040. The first agent may then change its value at step 1050. In some instances, different agents will have different values, such as for example price margin, and off-invoice discount, and other values. After the first agent changes its value, the method of FIG. 10 returns to step 1010.

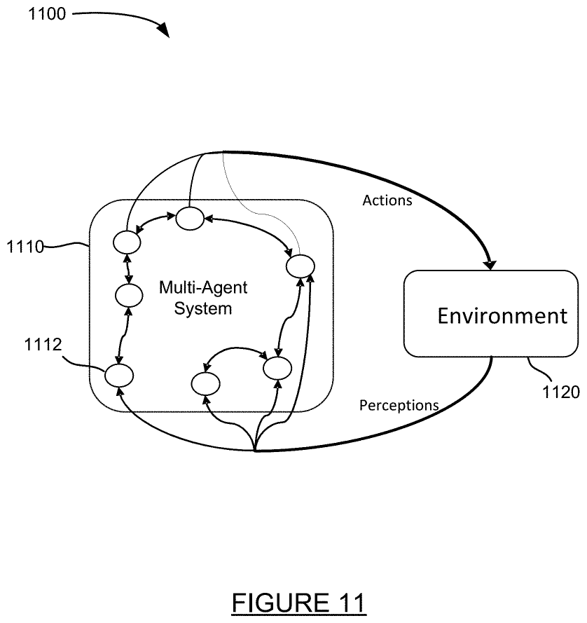

FIG. 11 illustrates a model of a multi-agent optimization system. The multi-agent optimization system 1100 includes multiple software agents 1112 within a multi-agent system 1110 that exchange messages to autonomously interact among each other and with their environment 1120 in order to meet the user-defined objectives. The messages may include forward messages in which a software agent 1112 informs other software agents of the values of their outputs based on the values of their inputs. The messages may also include backward messages to the software agents controlling their inputs.

The types of software agents 1112 can vary from embodiment to embodiment. In some embodiments, the software agents 1112 include variable agents. A variable agent is a software agent that represents a variable of the optimization (e.g., list price, discounts, etc.). In some embodiments, the software agents 1112 include computation agents. A computation agent is a software agent that represents direct computations of the optimization values (e.g., margin computation, turnover computation, etc.). In some embodiments, the software agents 1112 include criterion agents. A criterion agent is a software agent that represents optimization criteria such as targets, thresholds, and min/max constraints.

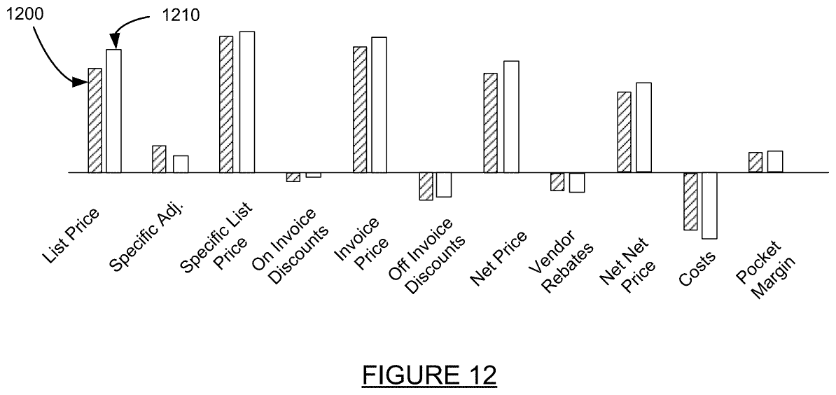

FIG. 12 illustrates exemplary initial price waterfall elements and optimized price waterfall elements. The optimized price waterfall has been optimized using the techniques described herein. In the illustrated example, the price waterfall elements include list price, specific adjustment, specific list price, on invoice discounts, invoice price, off invoice discounts, net price, vendor rebates, net price, costs, and pocket margin. In other embodiments, the price waterfall elements may be different. In the illustrated example, the optimized price waterfall 610 results in a revenue increase of approximately six percent and a profit increase of approximately one and a half percent.

FIG. 13 illustrates an exemplary interface for defining optimization data scope. The optimization scope values include customer scope values, products go values, and transaction scope values.

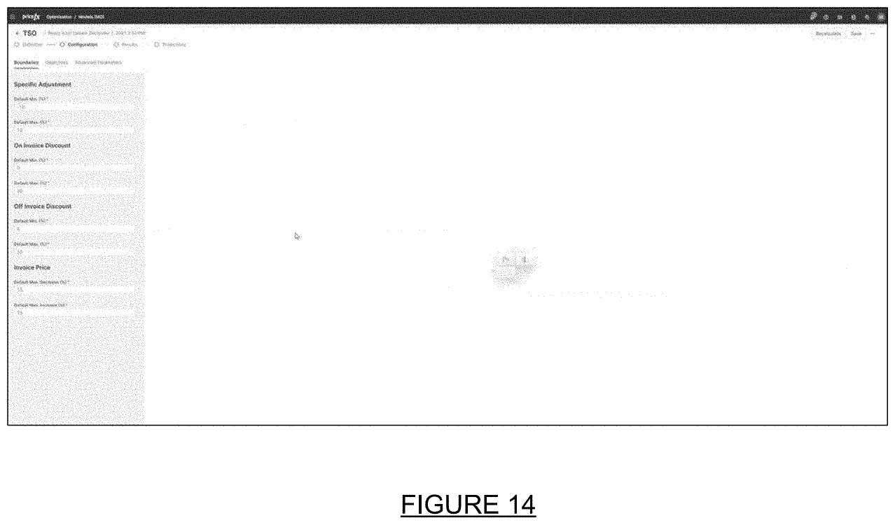

FIG. 14 illustrates an exemplary interface for receiving optimization configuration boundaries. The interface allows a user to provide input to set boundaries for performing an optimization of a price waterfall. The exemplary boundaries include specific adjustments, on invoice discounts, off invoice discounts, and invoice price. In some instances, other criteria may be received through the interface, for example based on a desired waterfall structure for a customer.

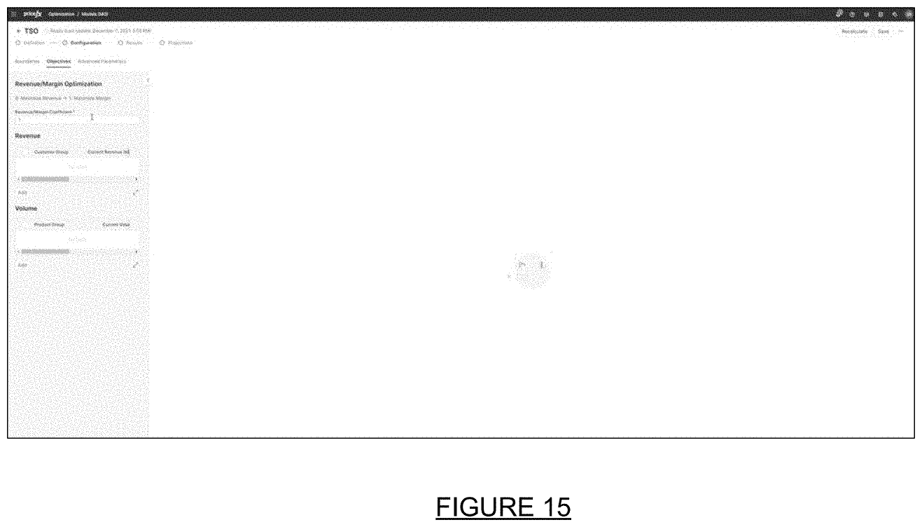

FIG. 15 illustrates an exemplary interface for receiving optimization configuration objectives. The interface allows a user to provide input to set objectives for performing an optimization of a price waterfall. The optimization objectives include a revenue margin optimization, revenue objective, and volume objective.

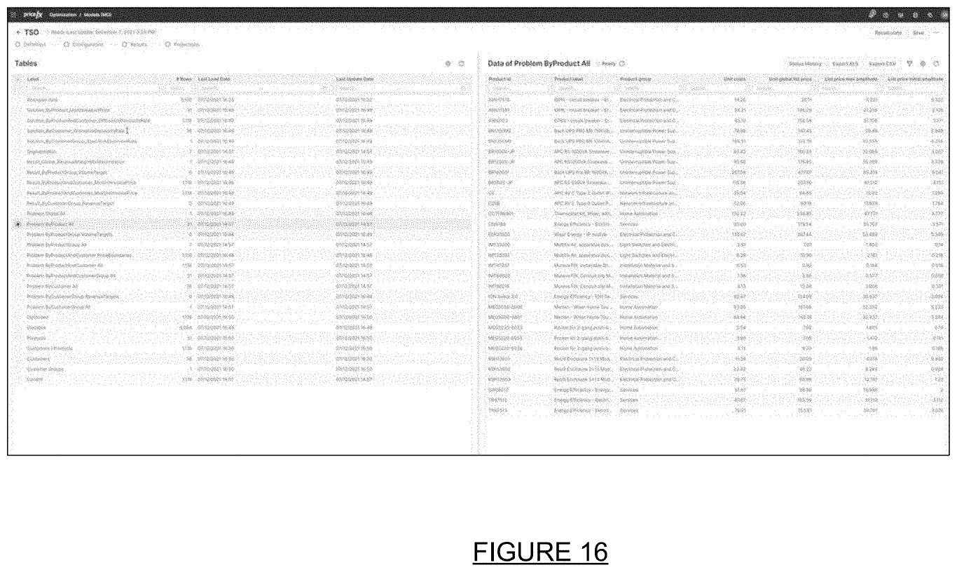

FIG. 16 illustrates an exemplary interface displaying table information. On the left side of interface 1600 includes a list of tables, the number of rows in each table, the last load date, and other information for each table. On the right side of interface 1600, the data for a selected table is displayed. In interface 1600, a table of “problem byproduct all” table is selected, and the data for that table is illustrated on the right side of the interface.

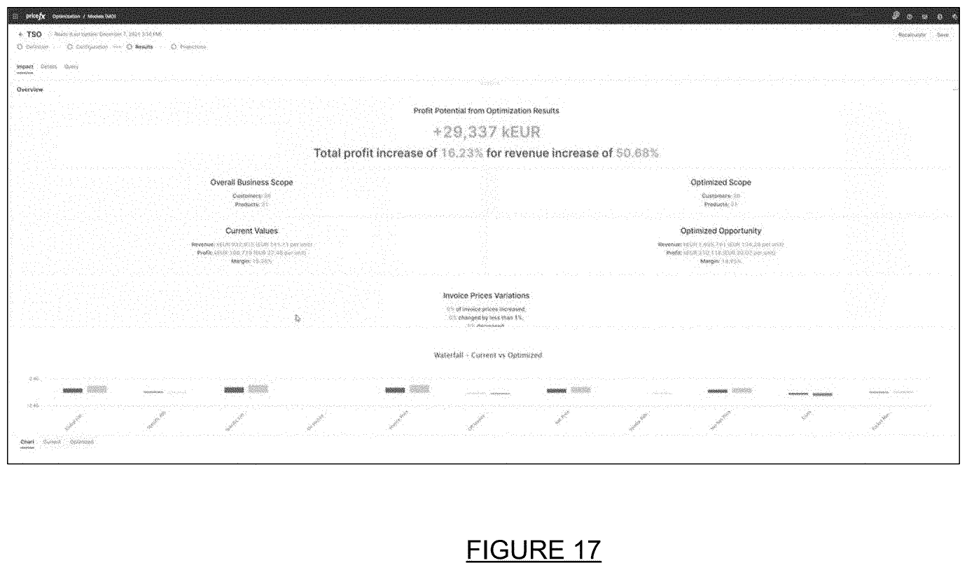

FIG. 17 illustrates an exemplary interface for displaying an overview of optimization results. Interface 1700 includes information such as overall business scope, current values for revenue, profit, and margin, invoice price variation, optimize scope with a number of customers and products, and op demised opportunity in terms of profits, revenue, and margin.

FIG. 18 illustrates an exemplary interface for displaying an initial price waterfall and optimized price waterfall. The interface 1800 of FIG. 18 includes the results of the optimization. The results include initial and optimized values for each of global unit price, specific adjustments, specific list price, on invoice discount, invoice price, off invoice discounts, net price, vendor rebates, net price, costs, and pocket margin. The interface can display revenue per product group as well as margin per product group.

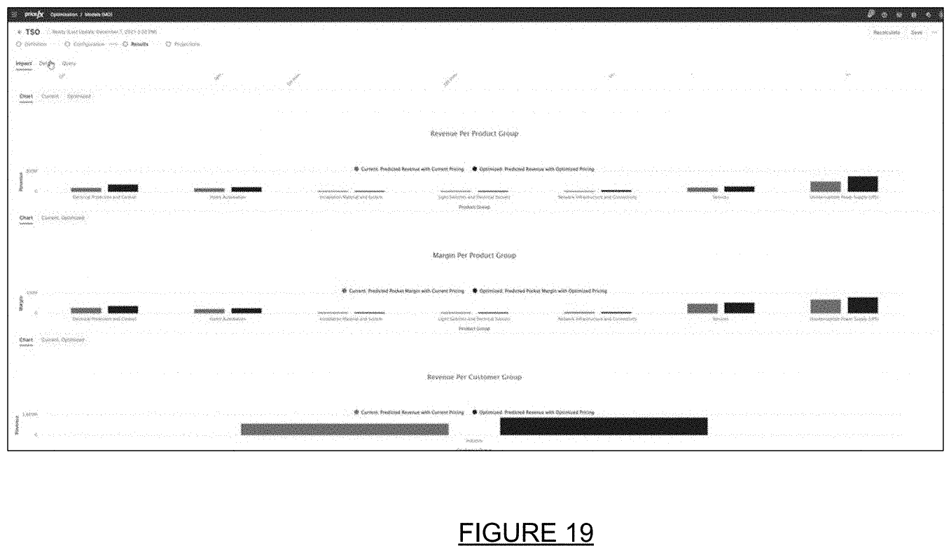

FIG. 19 illustrates an exemplary interface for displaying revenue and margin data. Interface 1900 of FIG. 19 illustrates additional information for revenue per product group, margin per product group, and revenue per customer group.

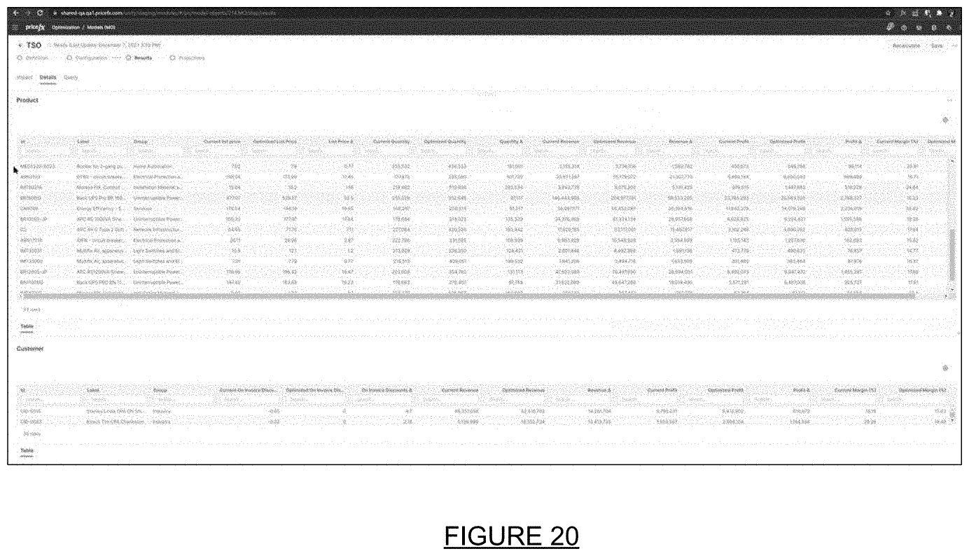

FIG. 20 illustrates an exemplary interface for displaying optimization result details. The interface 2000 of FIG. 20 provides results data in a table format. For example, for each product listed in the first row the table, label, group, and price waterfall element data is provided for each particular product.

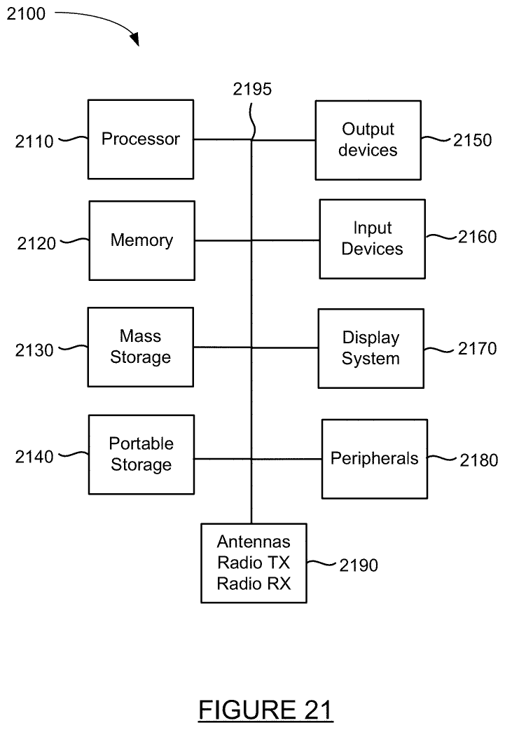

FIG. 21 is a block diagram of a computer system 2100 for implementing the present technology. System 2100 of FIG. 21 may be implemented in the contexts of the likes of client 110, optimization server 150, and data store 170.

The computing system 2100 of FIG. 21 includes one or more processors 2110 and memory 2120. Main memory 2120 stores, in part, instructions and data for execution by processor 2110. Main memory 2110 can store the executable code when in operation. The system 2100 of FIG. 21 further includes a mass storage device 2130, portable storage medium drive(s) 2140, output devices 2150, user input devices 2160, a graphics display 2170, and peripheral devices 2180.

The components shown in FIG. 21 are depicted as being connected via a single bus 2190. However, the components may be connected through one or more data transport means. For example, processor unit 2110 and main memory 2120 may be connected via a local microprocessor bus, and the mass storage device 2130, peripheral device(s) 2180, portable or remote storage device 2140, and display system 2170 may be connected via one or more input/output (I/O) buses.

Mass storage device 2130, which may be implemented with a magnetic disk drive or an optical disk drive, is a non-volatile storage device for storing data and instructions for use by processor unit 2110. Mass storage device 2130 can store the system software for implementing embodiments of the present invention for purposes of loading that software into main memory 620.

Portable storage device 2140 operates in conjunction with a portable non-volatile storage medium, such as a compact disk, digital video disk, magnetic disk, flash storage, etc. to input and output data and code to and from the computer system 2100 of FIG. 21. The system software for implementing embodiments of the present invention may be stored on such a portable medium and input to the computer system 2100 via the portable storage device 640.

Input devices 2160 provide a portion of a user interface. Input devices 2160 may include an alpha-numeric keypad, such as a keyboard, for inputting alpha-numeric and other information, or a pointing device, such as a mouse, a trackball, stylus, or cursor direction keys. Additionally, the system 2100 as shown in FIG. 21 includes output devices 2150. Examples of suitable output devices include speakers, printers, network interfaces, and monitors.

Display system 2170 may include a liquid crystal display (LCD), LED display, touch display, or other suitable display device. Display system 2170 receives textual and graphical information, and processes the information for output to the display device. Display system 2170 may receive input through a touch display and transmit the received input for storage or further processing.

Peripherals 2180 may include any type of computer support device to add additional functionality to the computer system. For example, peripherals 2180 may include a modem or a router.

The components contained in the computer system 2100 of FIG. 21 can include a personal computer, handheld computing device, tablet computer, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Apple OS or iOS, Android, and other suitable operating systems, including mobile versions.

When implementing a mobile device such as smart phone or tablet computer, or any other computing device that communicates wirelessly, the computer system 2100 of FIG. 21 may include one or more antennas, radios, and other circuitry for communicating via wireless signals, such as for example communication using Wi-Fi, cellular, or other wireless signals.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for simultaneously optimizing price waterfall elements, the method comprising:
receiving, by a server having one or more processors and memory, an initial price waterfall comprising a plurality of initial price waterfall elements, the initial price waterfall associated with a product and having a plurality of successive pricing deductions;
receiving domain data comprising historical transaction data associated with the initial price waterfall;
optimizing, by a multi-agent optimization engine, the plurality of initial price waterfall elements of the initial price waterfall based on the domain data, thereby forming an optimized price waterfall; and
reporting the optimized price waterfall to a user.

2. The method of claim 1, further comprising receiving a revenue/profit coefficient input by the server and from the user, and wherein the optimizing by the multi-agent optimization engine is further based on the revenue/profit coefficient.

3. The method of claim 2, wherein the multi-agent optimization engine is responsive to a first value of the revenue/profit coefficient to maximize revenue of the optimized price waterfall, and is responsive to a second value of the revenue/profit coefficient to maximize profit of the optimized price waterfall.

4. The method of claim 1, wherein the plurality of initial price waterfall elements comprises an initial list price, an initial on invoice discount, an initial off invoice rebate, and an initial end of period discount.

5. The method of claim 4, wherein the multi-agent optimization engine simultaneously optimizes each of the plurality of initial price waterfall elements.

6. The method of claim 1, wherein the adaptive multi-agent optimization engine comprises at least one of a variable agent, a computation agent, and a criterion agent.

7. A non-transitory computer readable storage medium having embodied thereon a program, the program being executable by a processor to perform a method for optimizing a price waterfall, the method comprising:
receiving, by a server having one or more processors and memory, an initial price waterfall comprising a plurality of initial price waterfall elements, the initial price waterfall associated with a product and having a plurality of successive pricing deductions;
receiving domain data comprising historical transaction data associated with the initial price waterfall;
optimizing, by a multi-agent optimization engine, the plurality of initial price waterfall elements of the initial price waterfall based on the domain data, thereby forming an optimized price waterfall; and
reporting the optimized price waterfall to a user.

8. The non-transitory computer readable storage medium of claim 7, the method further comprising receiving a revenue/profit coefficient input by the server and from the user, and wherein the optimizing by the multi-agent optimization engine is further based on the revenue/profit coefficient.

9. The non-transitory computer readable storage medium of claim 8, wherein the multi-agent optimization engine is responsive to a first value of the revenue/profit coefficient to maximize revenue of the optimized price waterfall, and is responsive to a second value of the revenue/profit coefficient to maximize profit of the optimized price waterfall.

10. The non-transitory computer readable storage medium of claim 7, wherein the plurality of initial price waterfall elements comprises an initial list price, an initial on invoice discount, an initial off invoice rebate, and an initial end of period discount.

11. The non-transitory computer readable storage medium of claim 10, wherein the multi-agent optimization engine simultaneously optimizes each of the plurality of initial price waterfall elements.

12. The non-transitory computer readable storage medium of claim 7, wherein the adaptive multi-agent optimization engine comprises at least one of a variable agent, a computation agent, and a criterion agent.

13. A system for optimizing a price waterfall, the system comprising:
a server including a memory and a processor; and
instructions stored in the memory and executed by the processor to:
receive an initial price waterfall comprising a plurality of initial price waterfall elements, the initial price waterfall associated with a product and having a plurality of successive pricing deductions;
receive domain data comprising historical transaction data associated with the initial price waterfall;
optimize, by a multi-agent optimization engine, the plurality of initial price waterfall elements of the initial price waterfall based on the domain data, thereby forming an optimized price waterfall; and
report the optimized price waterfall to a user.

14. The system of claim 13, wherein the instructions stored in memory and executed by the processor is further to receive a revenue/profit coefficient input by the server and from the user, and wherein the instructions stored in memory and executed by the processor to optimize by the multi-agent optimization engine is further based on the revenue/profit coefficient.

15. The system of claim 14, wherein the multi-agent optimization engine is responsive to a first value of the revenue/profit coefficient to maximize revenue of the optimized price waterfall, and is responsive to a second value of the revenue/profit coefficient to maximize profit of the optimized price waterfall.

16. The system of claim 13, wherein the plurality of initial price waterfall elements comprises an initial list price, an initial on invoice discount, an initial off invoice rebate, and an initial end of period discount.

17. The system of claim 16, wherein the multi-agent optimization engine simultaneously optimizes each of the plurality of initial price waterfall elements.

18. The system of claim 13, wherein the adaptive multi-agent optimization engine comprises at least one of a variable agent, a computation agent, and a criterion agent.
